(19) United States
(12) Patent Application Publication
(10) Pub. No.: US 2001/0021062 A1
(43) Pub. Date: Sep. 13, 2001

(54) Configuration for transmitting high-power pumping light

(76) Inventor: Walter Probster, Munchen (DE)

Correspondence Address: LERNER AND GREENBERG, P.A., Post Office Box 2480, Hollywood, FL, 33022-2480, US

(21) Appl. No.: 09/742,269

(22) Filed: Dec. 20, 2000

(30) Foreign Application Priority Data
Dec. 20, 1999 (DE) 199 61 515.2

(51) Int. Cl. H01S 3/00

(52) U.S. Cl. 359/341.33

(57) ABSTRACT

The power of the pumping light to be transmitted is limited by the Raman effect. In order to alleviate the problems associated with this, pumping signals having different wavelengths are transmitted via a number of optical fibers, are combined in a coupling device at the fiber amplifier, and are fed into an amplifier fiber.

### BACKGROUND OF THE INVENTION

Field of the Invention

The invention relates to a configuration for transmitting high-power pumping light for remotely feeding a fiber amplifier.

When data are being transmitted via optical fibers, the attenuation of the fibers in long transmission paths frequently makes it necessary to use optical fiber amplifiers. A fiber amplifier essentially comprises a fiber which is generally doped with erbium, a coupling device for injecting the pumping light into the fiber, and a control device.

If it is impossible, or undesirable for accessibility reasons, to arrange the pumping source in the vicinity of the fiber amplifier, then the pumping light is transmitted via an additional fiber to the fiber amplifier. There it can be fed in either in the opposite direction or in the same direction as the data transmission direction. It is likewise possible to feed the pumping light in simultaneously in both directions. Pumping light at a wavelength of approximately 1480 nm is used, which is attenuated only slightly. Wavelength multiplexers are generally used for injection into the transmission fiber, once again for attenuation reasons.

International PCT publication WO 95/10868 discloses a fiber amplifier which is fed from a multimode laser source. There, the pumping light is fed into the core, which is used for data transmission, via the cladding or via a further concentric fiber core. If a multimode laser source is used to produce the pumping light, it must be remembered that, although high power levels can be transmitted via multimode fibers, their attenuation is greater than that with monomode fibers.

If, on the other hand, a monomode fiber is used, then the power level is limited to about one Watt, owing to the Raman effect. This pumping power is insufficient to bridge long transmission paths, however.

### SUMMARY OF THE INVENTION

The object of the present invention is to provide a transmission configuration for high-power pumping light which overcomes the above-noted deficiencies and disadvantages of the prior art devices and methods of this general kind, and which is improved to exhibit only low losses.

With the above and other objects in view there is provided, in accordance with the invention, a configuration for transmitting high-power pumping light for remotely feeding a fiber amplifier. The configuration comprises:

a plurality of pumping-light sources having different wavelengths;

at least one coupling device; and

a plurality of optical fibers connecting the plurality of pumping-light sources to the at least one coupling device, for parallel transmission of the pumping signals into the amplifier fiber of the fiber amplifier.

The pumping signals are thereby fed via the coupling device directly into the amplifier fiber, or combined in a further coupling device to form a pumping-light multiplex signal and output to the amplifier fiber.

With the above and other objects in view there is also provided, in accordance with the invention, a configuration for transmitting high-power pumping light for remotely feeding a multiclad fiber amplifier. The configuration comprises:

a plurality of pumping-light sources with different wavelengths;

a plurality of optical couplers connected to the pumping-light sources via a plurality of fibers for transmitting the pumping signals;

the optical couplers being disposed to feed signals into an inner fiber core of the multiclad fiber amplifier. In other words, the pumping light is injected via appropriate optical couplers of the multiclad fiber amplifier.

In accordance with an added feature of the invention, the parallel-transmitted pumping signals have mutually different wavelengths.

In accordance with an additional feature of the invention, the fibers for transmitting the pumping signals are monomode fibers.

In accordance with another feature of the invention, the fiber amplifier or the multiclad amplifier are pumped at both ends.

In accordance with a concomitant feature of the invention, the pumping-light sources are longitudinal lasers.

The particular advantage of the invention is that low-attenuation monomode fibers can be used for remote feeding. Owing to the relatively long time constant of the energy states which are stimulated, fiber amplifiers can be pumped by multiplexed wavelength signals. One option for keeping the attenuation low where the pumping light is injected into the amplifier fiber is to use wavelength multiplexers for injection. A multiclad amplifier having a number of optical couplers likewise has the advantage that, in contrast to other optical couplers, the pumping light can be fed in with little attenuation.

Although the invention can be carried out with any type of optical fibers, the use of monomode fibers is generally preferable owing to the lower attenuation, with a frequency-multimode laser being used as the pumping-light source in order to avoid stimulated Brillouin scatter.

Other features which are considered as characteristic for the invention are set forth in the appended claims.

Although the invention is illustrated and described herein as embodied in an configuration for transmitting high-power pumping light, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of a fiber amplifier that is remotely pumped via wavelength multiplexers;

FIG. 2 is a schematic view of a remotely pumped multiclad fiber amplifier; and

FIG. 3 is a sectional and schematic view of a multiclad amplifier.

### DESCRIPTION OF THE PREFERRED EMBODIMENTS

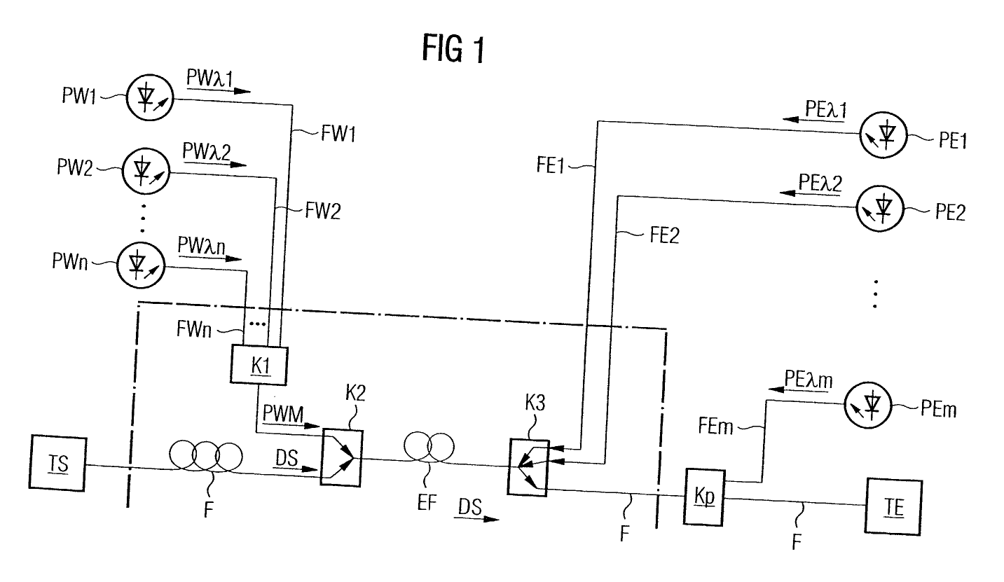

Referring now to the figures of the drawing in detail and first, particularly, to FIG. 1 thereof, there is seen a transmission device having a transmitting terminal TS of a transmission fiber F, a fiber amplifier K2, EF, K3 and a receiving terminal TE. If the terminals are designed appropriately, the configuration is in principle also suitable for bidirectional data transmission. If access to the fiber amplifier K2, EF, K3 is difficult, for example in underwater transmission systems, and the data transmission also has to cover a very long distance, then it is necessary to supply a considerable amount of pumping power to the fiber amplifier. “Longitudinal” multimode lasers, which emit a broadband spectrum, are used as the pumping-signal sources PW1 to PWn. The wavelengths λ1 to λn of the pumping signals PWλ1 to PWλn each have different wavelengths in the 1480 nm wavelength band. Each pumping signal PWλ1 to PWλn is transmitted via a separate monomode fiber FW1 to FWn (a number of low-power pumping signals at different wavelengths can also be transmitted jointly via one fiber), and are combined in a first coupling device K1, a wavelength multiplexer, via optical filters to form a multiplex pumping signal PWM. The data signal DS to be transmitted and the multiplex pumping signal PWM are fed into an amplifying fiber EF (doped, for example, with erbium) via a second coupling device K2, which is likewise in the form of a wavelength multiplexer, in order to keep the attenuation low. The two coupling devices can be combined. The pumping signals can also be fed into an amplifier fiber via a number of these coupling devices K1 and/or K2.

In this exemplary embodiment, further pumping-light sources PE1 and PE2 are also used for feeding in in the opposite direction to the transmission direction of the data signal DS, and their pumping signals PEλ1 and PEλ2 are transmitted via separate fibers FE1 and FE2 to a third coupling device KE3, which is in the form of a wavelength multiplexer and wavelength demultiplexer. The coupling device K3 is used not only to feed in the two pumping signals, but also for branching out (or feeding in along the same direction) the data signal. Yet another coupling device Kp is provided via which a further pumping signal PEλm is fed into the transmission fiber in the opposite direction to the transmission direction of the data signal, and is supplied to the fiber amplifier via the third coupling device K3. The process of feeding into the transmission fiber results in further signal amplification, owing to the Raman effect.

In the exemplary embodiment, most of the pumping-light sources are accommodated together with the transmitting terminal TS on land, while the fiber amplifier is arranged approximately in the center of the underwater cable. Only one pumping light source PEm, which is provided for pumping in the opposite direction, is arranged at the receiving terminal's TE end. The various areas are delineated by dash-dotted lines.

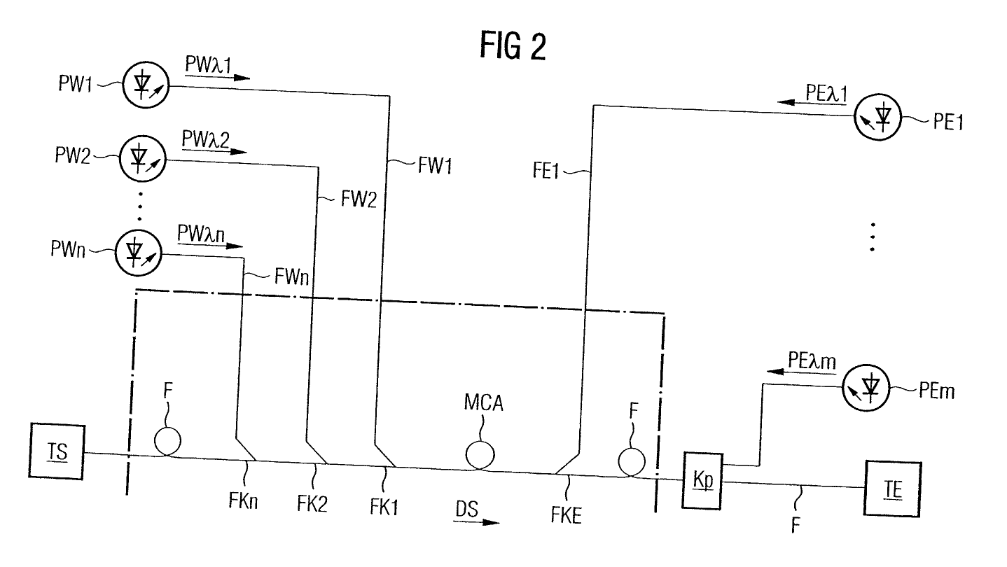

Referring now to FIG. 2, there is shown a corresponding configuration, but using a multiclad fiber amplifier MCA having a number of fiber couplers FK1 to FKn, FKE. All the other elements of the second embodiment correspond to those illustrated in FIG. 1.

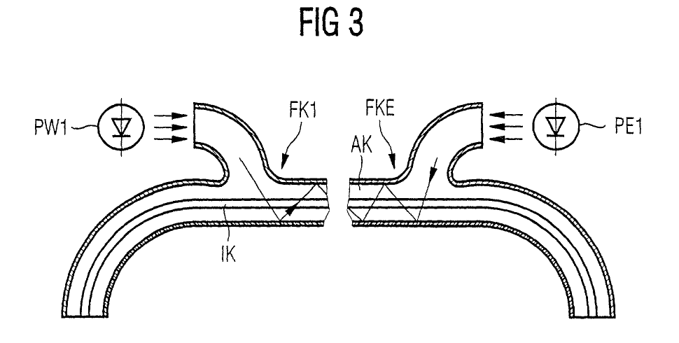

Referring now to FIG. 3, there is shown such a multiclad fiber amplifier, with two fiber couplers FK1, FKE, in more detail. The pumping signals are injected into an inner fiber core from an outer fiber core AK. The fiber couplers allow the pumping light to be fed in with relatively low losses.

In FIG. 2, the pumping signals PWλ1 to PWλn are once again transmitted via separate fibers FW1 to FWn. In addition, a further fiber coupler FKE is provided for feeding in pumping light in the opposite direction, which is connected to the pumping light source PE1 via the fibers FE1. In this case as well, the pumping light can also be fed in from the pumping light source PEm via the further coupling device Kp.

For completeness, it should also be mentioned that light at the same wavelength can be used for feeding in not only in the same direction but also in the opposite direction.

I claim:

1. A configuration for transmitting high-power pumping light for remotely feeding a fiber amplifier having an amplifier fiber, the configuration comprising:
a plurality of pumping-light sources having different wavelengths;
at least one coupling device; and
a plurality of optical fibers connecting said plurality of pumping-light sources to said at least one coupling device, for parallel transmission of the pumping signals into the amplifier fiber of the fiber amplifier.

2. The configuration according to claim 1, wherein the pumping signals are fed via said coupling device directly into the amplifier fiber.

3. The configuration according to claim 1, which comprises a further coupling device wherein the pumping signals are combined to form a pumping-light multiplex signal and output to the amplifier fiber.

4. The configuration according to claim 1, wherein the parallel-transmitted pumping signals have mutually different wavelengths.

5. The configuration according to claim 1, wherein said plurality of fibers are monomode fibers for transmitting the pumping signals.

6. The configuration according to claim 1, wherein the fiber amplifier has two ends and the configuration is arranged to pump the fiber amplifier at both ends.

7. The configuration according to one claim 1, wherein said pumping-light sources are longitudinal lasers.

8. A configuration for transmitting high-power pumping light for remotely feeding a multiclad fiber amplifier having an inner fiber core, comprising:
a plurality of pumping-light sources with different wavelengths;
a plurality of optical couplers connected to said pumping-light sources via a plurality of fibers for transmitting the pumping signals;
said optical couplers being disposed to feed signals into an inner fiber core of the multiclad fiber amplifier.

9. The configuration according to claim 8, wherein the parallel-transmitted pumping signals have mutually different wavelengths.

10. The configuration according to claim 8, wherein said plurality of fibers are monomode fibers for transmitting the pumping signals.

11. The configuration according to claim 8, wherein the amplifier has two ends and the configuration is arranged to pump the multiclad amplifier at both ends.

12. The configuration according to one claim 8, wherein said pumping-light sources are longitudinal lasers.
